(19) United States
(12) Patent Application Publication
(10) Pub. No.: US 2020/0122907 A1
(43) Pub. Date: Apr. 23, 2020

(54) Sediment-Trapping Bottle Cap

(71) Applicant: Timothy J. Campbell, Beijing (CN)

(72) Inventor: Timothy J. Campbell, Beijing (CN)

(21) Appl. No.: 16/599,635

(22) Filed: Oct. 11, 2019

Related U.S. Application Data
(60) Provisional application No. 62/749,157, filed on Oct. 23, 2018.

(51) Int. Cl. B65D 51/24; B65D 41/04; C12H 1/07

(52) U.S. Cl. CPC B65D 51/24; C12H 1/063; B65D 41/04

(57) ABSTRACT

A sediment-trapping bottle cap for removing solids such as sediment from homemade beer, wine, or other liquids with impurities. The bottle cap uses a collection receptacle that rotates gravitationally. The sediment-trapping bottle cap is generally used with a container such as a standard or specially-made bottle. The cap includes a cap body that houses a receptacle, which can rotate gravitationally within the cap when it is inverted or otherwise not upright. The cap can be removed and any settled sediment can be discarded.

### CROSS REFERENCE TO RELATED APPLICATIONS

I hereby claim benefit under Title 35, United States Code, Section 119(e) of U.S. provisional patent application Ser. No. 62/749,157, filed Oct. 23, 2018. The 62/749,157 application is currently pending. The 62/749,157 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a sediment-trapping bottle cap for removing solids such as sediment from homemade beer and wine or other liquids with impurities.

### Related Art

Any discussion of the related art throughout the specification should in no way be considered as an admission that such related art is widely known or forms part of common general knowledge in the field.

When making beer, wine, or other beverages in small batches, such as in individual bottles, the process can produce sediment that will ordinarily become trapped in the bottle in which the beverage is being produced. Various mechanisms for separating such sediment from the liquid beverage have been in use for a number of years.

However, often such products require special equipment, and have complex mechanisms that can also be difficult to clean, or which can affect the properties of the beverage, such as carbonation levels or taste. Further, other sediment traps and mechanisms can be relatively expensive, or difficult to manufacture.

### SUMMARY

An example embodiment is directed to a sediment-trapping bottle cap. The sediment-trapping bottle cap includes a cap body comprising a body opening and a chamber, a socket in the cap body, and a receptacle adapted to fit within the chamber, the receptacle comprising a receptacle opening and a ball member sized to be rotatably positioned in the socket such that the receptacle is rotatable within the chamber.

In an example embodiment, the socket may include two sockets, one on either side of the cap body, and the ball member may include two ball members on either side of the receptacle such that each ball member is positioned in each socket. Further, the two ball members may be positioned proximate the receptacle opening, and the center of mass of the receptacle may be below the receptacle opening such that the receptacle is suspended from the two ball members with the receptacle opening facing up.

In another example embodiment, the body opening may include threads adapted to mate with a bottle, such as a standard beer or wine bottle, or one with a known, uniform size and thread pattern. Further, the receptacle may be substantially hemispherical, and the receptacle may further include a collection area to collect sediment.

In some embodiments of the sediment-trapping bottle cap, the cap body is integrally formed from a single material, such as a compliant material, plastic, etc.

An example embodiment may also include a method of using any variation or embodiment of the sediment-trapping bottle cap, the method generally comprising: attaching the sediment-trapping bottle cap to a bottle containing a liquid; inverting the bottle with the sediment-trapping bottle cap in place; allowing sediment to settle into the receptacle; and rotating the bottle to an upright position while substantially maintaining an orientation of the bottle, such that the receptacle is able to rotate inside the cap body due to gravity.

In still another example embodiment, the sediment-trapping bottle cap can include a cap body comprising a first opening and a chamber, a pivot means in the cap body; and a means for sediment collection adapted to fit within the chamber, the means for sediment collection comprising a second opening and a ball member sized to be rotatably positioned in the socket such that the means for sediment collection is rotatable within the chamber.

In an example embodiment including the means for sediment collection, the socket may include two sockets, one on either side of the cap body, and wherein the ball member may include two ball members on either side of the means for sediment collection such that each ball member is positioned in each socket. Moreover, the two ball members may be positioned proximate the second opening, and the center of mass of the receptacle may be below the second opening such that the means for sediment collection is suspended from the two ball members with the second opening facing up. The first opening may include threads adapted to mate with a bottle.

There has thus been outlined, rather broadly, some of the embodiments of the sediment-trapping bottle cap in order that the detailed description thereof may be better understood, and in order that the present contribution to the art may be better appreciated. There are additional embodiments of the sediment-trapping bottle cap that will be described hereinafter and that will form the subject matter of the claims appended hereto. In this respect, before explaining at least one embodiment of the sediment-trapping bottle cap in detail, it is to be understood that the sediment-trapping bottle cap is not limited in its application to the details of construction or to the arrangements of the components set forth in the following description or illustrated in the drawings. The sediment-trapping bottle cap is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a sediment-trapping bottle cap in accordance with an example embodiment.

FIG. 2 is an exploded view of a sediment-trapping bottle cap in accordance with an example embodiment.

FIG. 3 is another exploded view of a sediment-trapping bottle cap in accordance with an example embodiment.

FIG. 4 is a detail exploded view of a sediment-trapping bottle cap in accordance with an example embodiment.

FIG. 5 is a side view of a sediment-trapping bottle cap in accordance with an example embodiment.

FIG. 6 is a section view of a sediment-trapping bottle cap in accordance with an example embodiment.

FIG. 7 is another section view of a sediment-trapping bottle cap in accordance with an example embodiment.

FIG. 8 is another section view of a sediment-trapping bottle cap in accordance with an example embodiment.

FIG. 9 is another section view of a sediment-trapping bottle cap in accordance with an example embodiment.

FIG. 10 is another section view of a sediment-trapping bottle cap in use in accordance with an example embodiment.

FIG. 11 is another section view of a sediment-trapping bottle cap in use in accordance with an example embodiment.

FIG. 12 is another section view of a sediment-trapping bottle cap in use in accordance with an example embodiment.

FIG. 13 is another section view of a sediment-trapping bottle cap in use in accordance with an example embodiment.

FIG. 14 is another section view of a sediment-trapping bottle cap in use in accordance with an example embodiment.

### DETAILED DESCRIPTION

### A. Overview.

An example sediment-trapping bottle cap 10 generally comprises a cap body 20 that has a chamber 24, wherein a collection receptacle 30 is positioned within the chamber 24 and rotationally held in place, such that the receptacle 30 rotates due to gravity. The cap body 20 may also have a body opening 28, and also, a pair of sockets 22 in the cap body 20. The sockets 22 may act in conjunction with mating ball members 32 on the receptacle 30 to form a ball/socket joint that allows the receptacle to be held and to rotate within the chamber 24 of the cap body 20. The receptacle 30 may have an opening 36 that allows sediment 50 to fall or enter the collection area 34 of the receptacle 30 when the bottle 40 is inverted.

The two sockets 22 may be positioned on either side of the cap body 20, and the ball members 32 may also be positioned on either side of the receptacle 30, such that each ball member 32 is positioned in each socket 22. Further, the two ball members 32 may be positioned proximate the receptacle opening 36, and the center of mass of the receptacle 30 may be below the receptacle opening 36, such that the receptacle 30 is suspended from the two ball members 32 with the receptacle opening 36 facing up.

The sediment-trapping bottle cap 10 may be used with a specially-made bottle 40, but it may also be used with any ordinary bottle 40, such as a standard beer or wine bottle, or a bottle with a known, uniform size and thread pattern. The cap 10 may have a substantially flat surface 21, which the bottle 40 may stand on when inverted.

The body opening 28 may include threads 26 adapted to mate with the threads 46 on bottle 40. Further, the receptacle 30 may be substantially hemispherical, and the receptacle may further include a collection area 34 to collect sediment 50.

In some embodiments of the sediment-trapping bottle cap, the cap body 20 may be integrally formed from a single material, such as a compliant material, plastic, etc.

An example embodiment may also include a method of using any variation or embodiment of the sediment-trapping bottle cap 10, the method generally comprising: attaching the sediment-trapping bottle cap 10 to a bottle 40 containing a liquid; inverting the bottle 40 with the sediment-trapping bottle cap 10 in place; allowing sediment 50 to settle into the receptacle 30, and more specifically, the collection area 34 of the receptacle 30; and rotating the bottle 40 to an upright position while substantially maintaining the orientation of the bottle with the sockets and thus the ball members 32 of the receptacle to remain on substantially the same level with each other, such that the receptacle 30 is able to rotate inside the cap body 20 due to gravity.

### B. Cap.

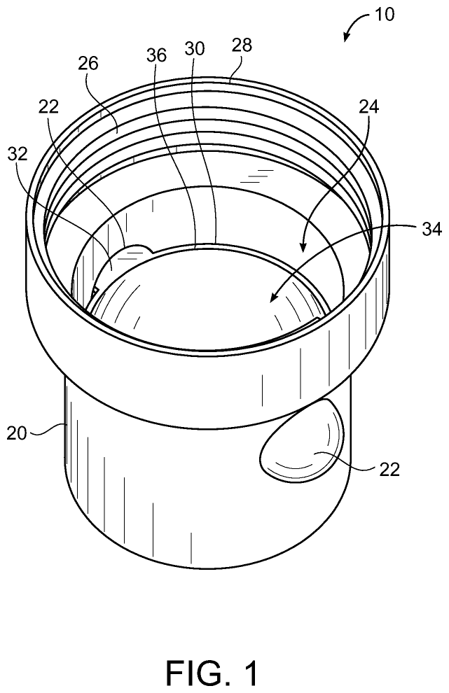

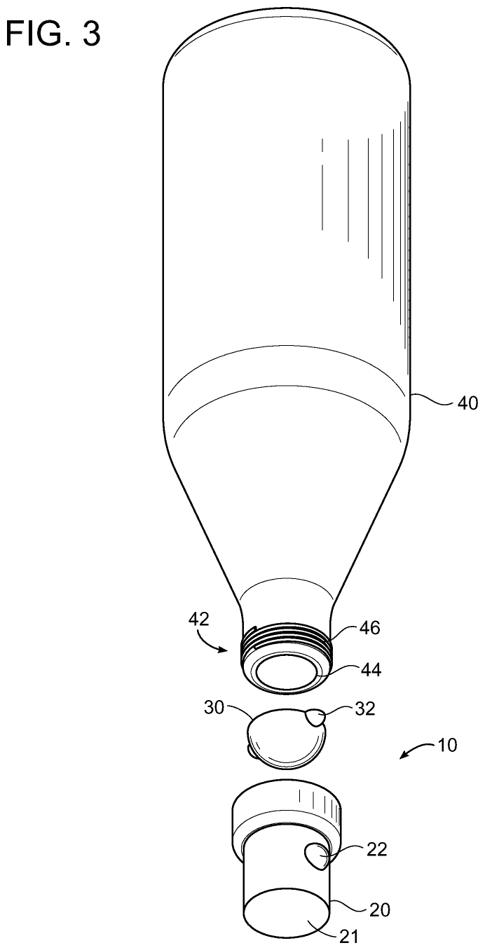

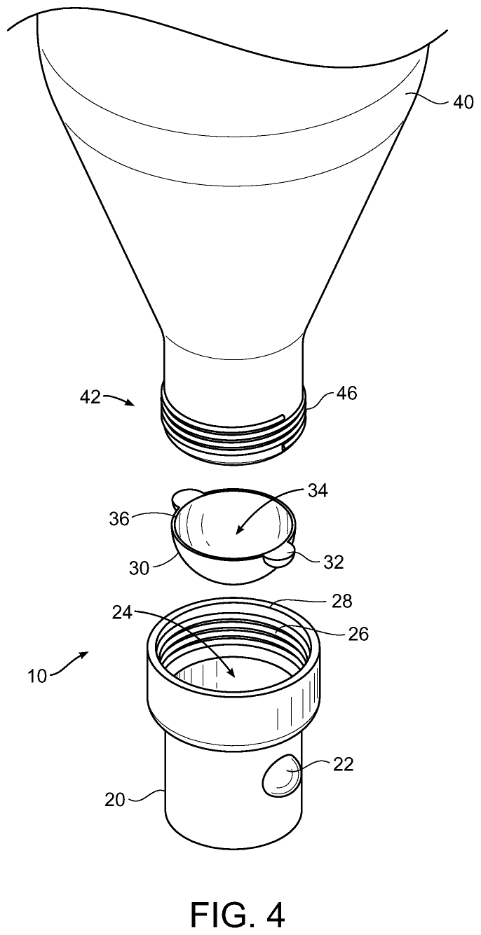

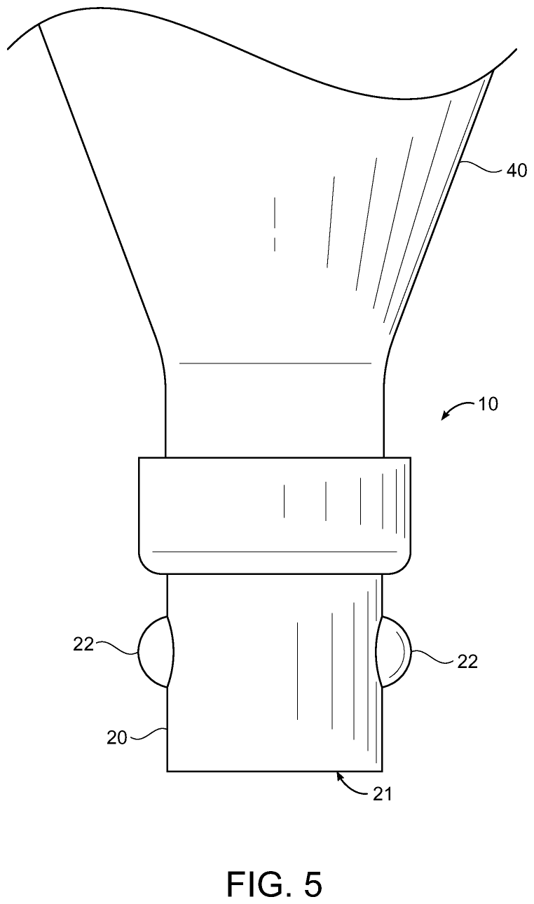

As best shown in FIGS. 1-4, the cap 10 is comprised of a substantially cylindrical cap body 20, which may have two sections with different diameters. The body 20 has an opening 28, which may have screw threads 26 on the interior portion of the cap body 20. The cap also includes an inner chamber 24, in which the removable receptacle 30 fits relatively closely, but with sufficient clearance to allow for rotation as will be described below. The cap body 20 may be fabricated from a single, integral material, such as plastic, and may have bubble-like sockets 22 formed in the sides of the body 20 at opposing positions, as best shown in FIGS. 5-9. Corresponding ball members 32 fit in the inside of the sockets 22.

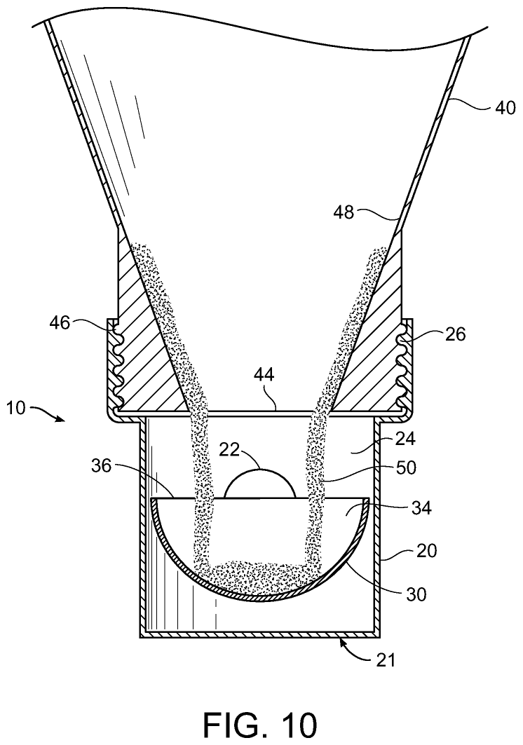

The cap 10 and receptacle may both be made of flexible material such as plastic, but one or both could also be made of other materials such as glass, stainless steel, etc., which could make removal of the receptacle more difficult, depending on the design, but which may have other advantages. Further, the cap 10 and receptacle 30 may be made with transparent material to allow for the observation of the process of aging and the precipitation and settling of sediment 50 into the collection area 34 of receptacle 30, as best shown in FIG. 10.

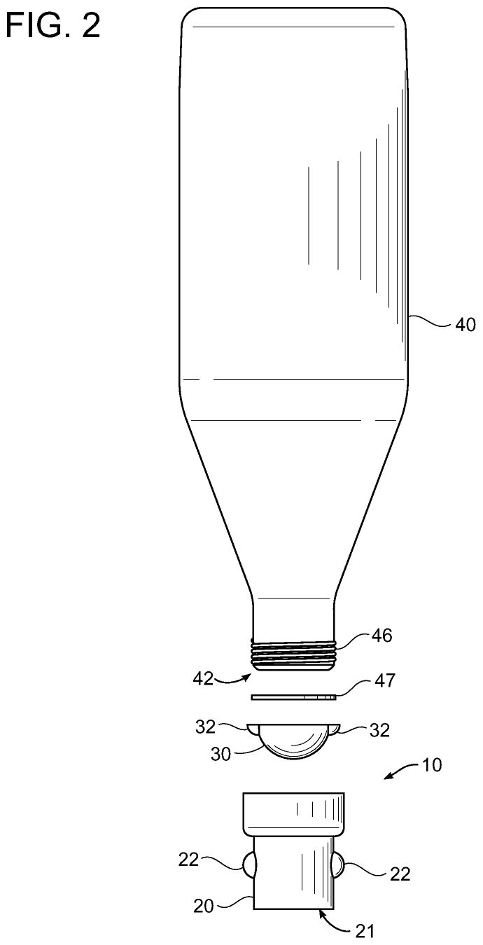

The cap 10 attaches to the container 40 by an attachment, such as screw threads 46 on the outside surface of the container 40 and a corresponding screw thread 26 the cap. The cap 10 houses the removable receptacle 30 that can rotate inside the cap 10 by a means of rotation such as a ball/socket joint comprised of socket 22 in the cap body 20, and corresponding ball members 32 near the top opening 36 of the receptacle 30. If flexible or compliant material such as plastic is used in making the cap 10, and specifically the cap body 20, the receptacle 30 can be easily inserted into, and removed from, cap body 20. If needed, an optional sealing washer 47 can be used to seal the connection between the bottle 40 and the cap 10, as shown in FIG. 2.

When the cap 10 is attached to the container 40 it maintains the opening 36 of the receptacle 30 in alignment with the opening 44 of the mouth 42 of the container 40. Because the inner rim of the mouth 42 of the container 40 is smaller in diameter than the opening 36 of the receptacle 30, this allows for sediment 50 to settle in the collection area 34 of the receptacle 30 without being impeded or gathering on any uneven or protruding surfaces. The flat surface 21 of the cap 10 may be enlarged to provide a better surface for supporting the container 40 in an inverted position.

The cap 10 could also be made to attach to the container 40 with other means of connection, such as a clasp. The cap 10 may also connect with the receptacle 30 by means such as a pin/socket joint.

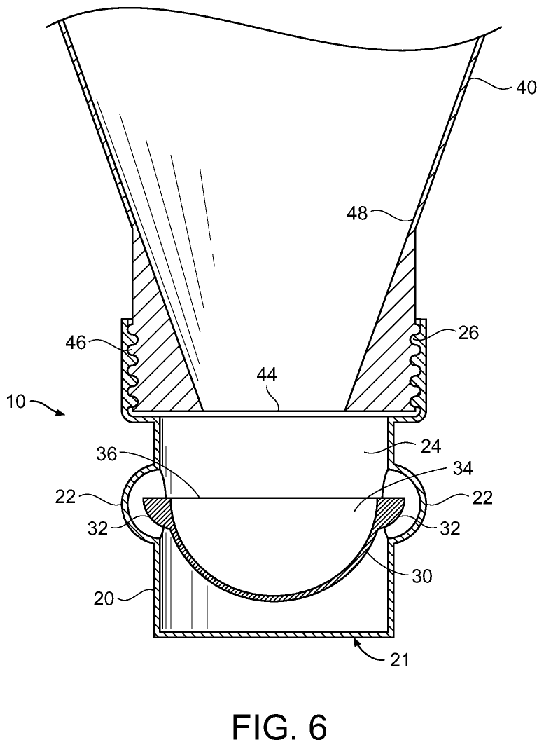

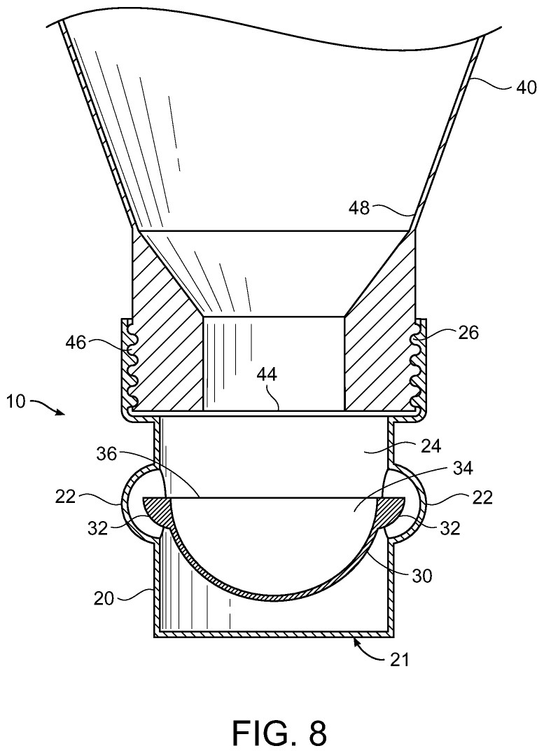

As mentioned above, the cap body 20 may be substantially cylindrical in shape, with an opening 28 at one end of the cylindrical body, and a flat surface 21 at the other, which also seals the chamber 24 of the body 20, as best shown in FIG. 6. The cylindrical body may be comprised of sections having a different diameter, which may be used to accommodate different bottle types. For example, the cap 10 may be specially made to mate with a non-standard bottle, such as the one shown in FIGS. 6 and 8. These bottles have a tapered inner neck 48, or an interior that is otherwise shaped or designed to smoothly funnel any sediment 50 in the liquid within the bottle 40 directly into the receptacle 30 when the bottle is inverted. Of course, even most or all standard bottles will also function this way, as any sediment present would tend to flow down into the opening of the bottle 40 unimpeded.

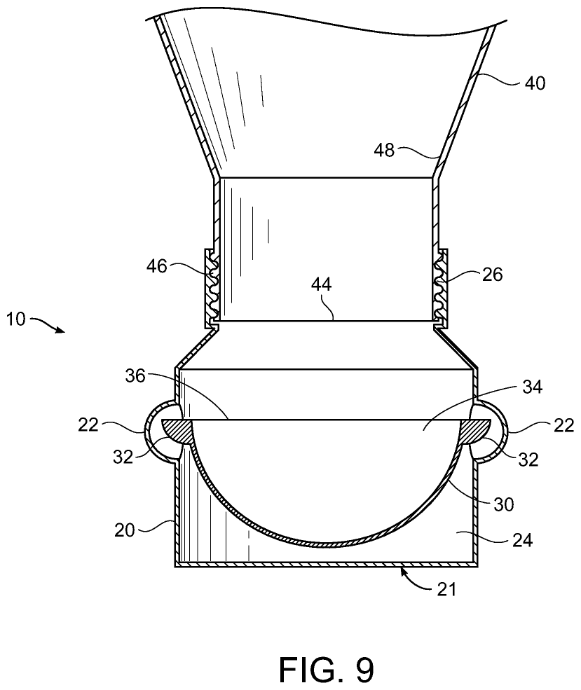

This arrangement may require a larger cap body 20 at the end having opening 28, in which case the open end of the cap body 20 may be larger than the portion with inner chamber 24, as shown for example in FIGS. 1-8 and 10-14. Of course, even if a special bottle is used, the cap proportions may be different than those shown without affecting the functioning of the example embodiments. In addition, the cap 10 can be used with standard bottles, as shown for example in FIG. 9, in which case the cap opening 28 may be smaller in diameter than the lower portion of the cap body 20. The cap may also be made having a cylindrical body 20 with the same diameter along its length.

### C. Receptacle.

The receptacle 30 is an element that fits within the cap body 20, and which is comprised of an opening 36, a sediment collection area 34, and ball members 32, which fit into the sockets 22 of the cap body 20 as discussed above. The receptacle is designed to rotate due to gravity such that its opening 36 remains facing up, so that any sediment that settles in the collection area 34 will remain in the receptacle, regardless of the orientation of the bottle 40 or the cap 10. Specifically, the receptacle stays oriented with its open end up whether the cap 10 is inverted, as shown in FIGS. 1-6 and 8-11. As also shown in the figures, the receptacle may be generally hemispherical in shape, although other shapes are possible without affecting the functioning of the embodiments disclosed herein.

As perhaps best shown in FIGS. 2-4 and 6-14, the receptacle 30 includes ball members 32 that are positioned or formed at the upper end of the receptacle 30, near the opening 36. Due to this placement, the center of mass of the receptacle 30 is well below the opening, and this condition is further aided by the weight of any sediment 50 that settles into the collection area 34 of the receptacle 30 during use, as shown in FIGS. 10-14. The center of mass and placement of ball members 32 causes the receptacle to stay oriented such that the opening 36 faces up, and sediment 50 stays in the collection area 34, as shown, even when the orientation of the bottle and cap changes. When the cap body 20, the receptacle 30, or both, are made from flexible material, the receptacle 30 may be readily removed from the cap 10 for easy cleaning of both the receptacle 30 and the inside of cap body 20.

### D. Operation of Preferred Embodiment.

Once homemade beer or wine has been fermented for the proper period of time, it is transferred from the large container in which it is fermented into individual containers 40 for aging. Wine can be transferred directly into the containers 40 as is, while for beer, a small amount of sugar is added in order to continue to process of fermentation in the container 40 and create carbon dioxide, which carbonates the beer and lends it an effervescent quality.

In either case, the aging process produces a small amount of sediment 50, which precipitates and settles to the bottom of the container 40 due to gravity (i.e., when a sediment-trapping bottle cap is not used). Once the container 40 is opened, this causes the carbon dioxide in the beer to escape upwards, roiling the sediment 50 on the bottom of the container 40. Pouring the wine or beer out of the container 40 further disturbs the sediment 50 and causes some of the sediment 50 to become suspended once again in the liquid. This causes discoloration and can negatively affect the taste and enjoyment of the beer or wine.

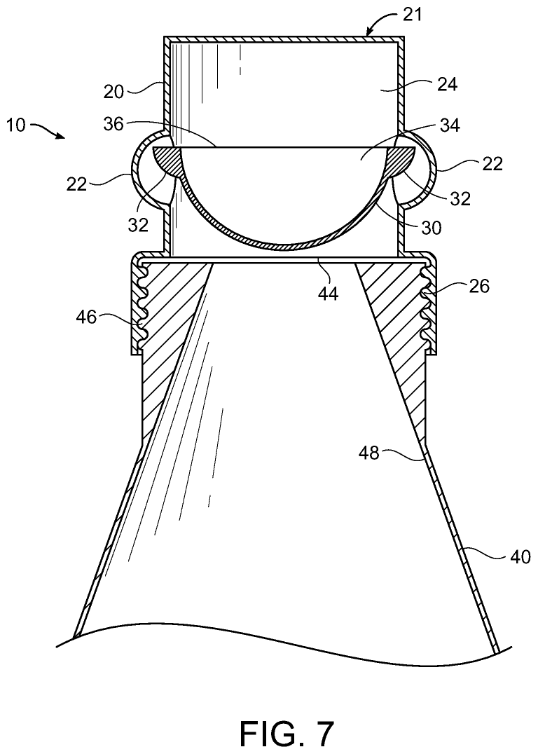

With the use of the sediment trapping cap 10, however, the sediment can be removed by the following procedure. In use, the receptacle 30 is installed into the cap body 20 (if it was not in that position initially), so that the ball members 32 are held by sockets 22, which allows the receptacle to freely rotate gravitationally within the chamber 24 of the cap 10. Next, the sediment-trapping bottle cap 10 is attached to an upright bottle 40 (see, e.g., FIG. 7) containing the liquid, such as by screwing or latching the cap 10 in place, also using an optional sealing washer 47 if desired or if the cap is designed to be used with a washer 47.

The sealed container 40 holding beer or wine can now be inverted for storage, for example, by being placed upside down on the flat surface 21 of the cap 10, as shown in representative FIGS. 8-9. Because the receptacle 30 rotates freely and gravitationally, its opening 36 remains facing upward, and the cap 10 that houses the receptacle 30 ensures that the opening 36 of the receptacle 30 remains aligned with (and below) the opening 44 of the container 40. When the sediment precipitates it falls downward due to gravity, and is guided by the tapered inner neck 48 of the bottle 40, which directs the sediment 50 into the receptacle 30. In this way, the sediment 50 produced by the aging process is held in the collection area 34 of the receptacle 30, rather than settling on the bottom of the bottle 40.

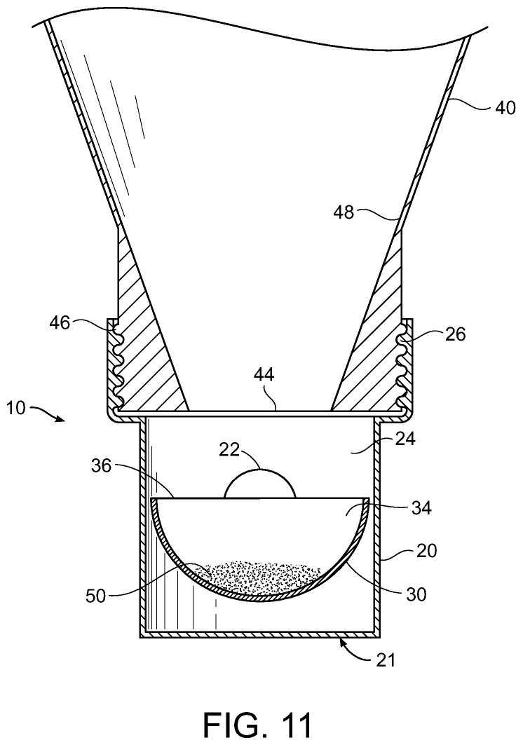

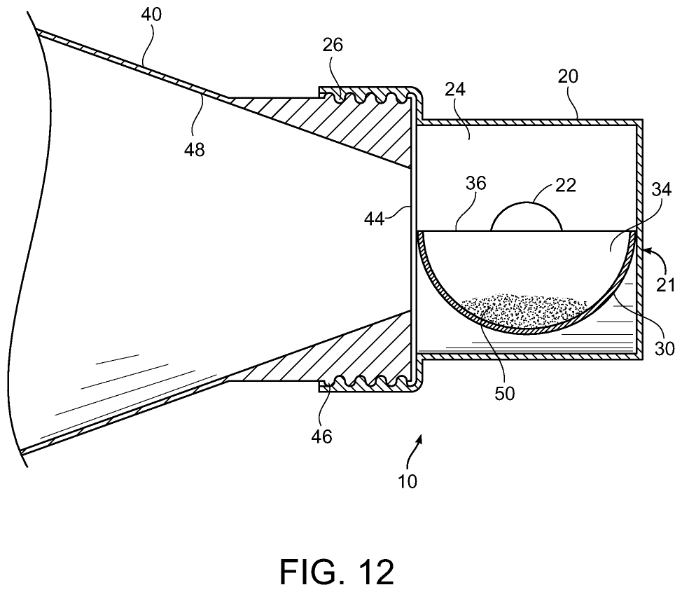

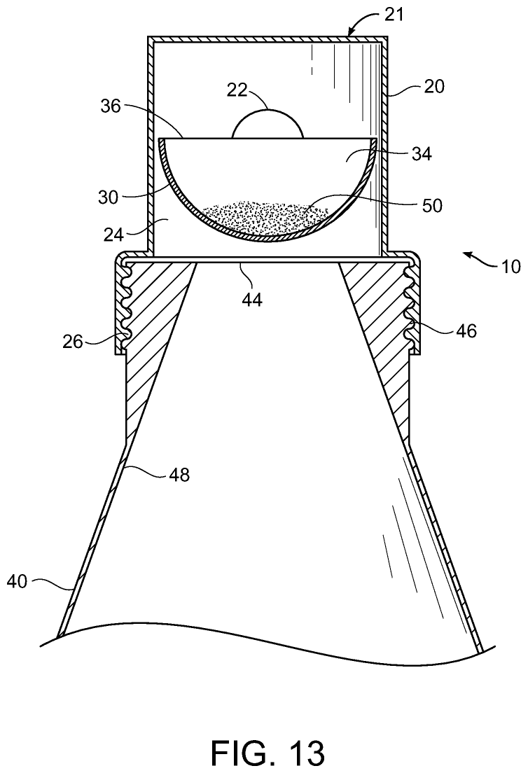

Once all of the sediment in the liquid has precipitated and settled (i.e., been allowed to settle) in the collection area 34, the container 40 can be set upright. Because the receptacle 30 holding the sediment can rotate due to gravity, it remains oriented with its opening 36 facing upward even when the container 40 is in different positions, as shown generally in FIGS. 9-14, and the sediment 50 is not disturbed. To accomplish this, the bottle 40 should be kept in the proper orientation such that the receptacle 30 can rotate freely. More specifically, the bottle or container 40 should be gently rotated with sockets 22 of the cap 10 on the same or substantially the same horizontal level. This is best illustrated in FIGS. 11 and 12, wherein the bottle 40 is rotated from an inverted position toward the left horizontal position of FIG. 12 with the sockets 22 and the ball members 32 (not shown) perpendicular to the page—in other words, with the sockets 22 and ball members 32 remaining on the same horizontal level. This procedure is continued in FIG. 13, wherein the bottle 40 is fully upright with the sediment 50 remaining within in the containment area 34 of the receptacle 30 due to the rotation of the receptacle.

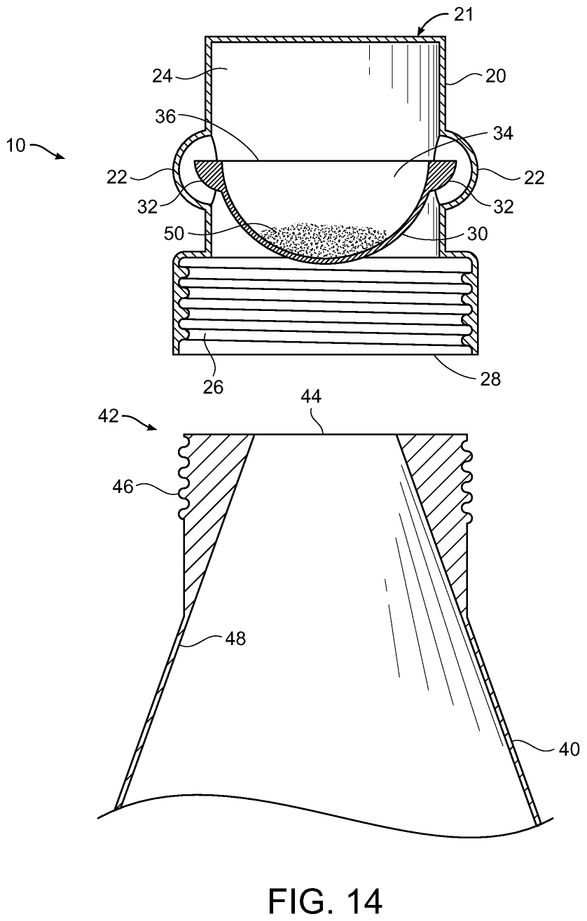

It is now possible to detach the cap 10 housing the receptacle 30 from the container 40 and set it aside, as shown in FIG. 14. This separates the sediment from the liquid in the container 40. The beer, wine, or other liquid can now be poured out of the container 40 into a glass without becoming tainted or contaminated by the sediment 50. This improves the color and taste of the beer or wine.

Unless otherwise defined, all technical and scientific terms used herein have the same meaning as commonly understood by one of ordinary skill in the art to which this invention belongs. Although methods and materials similar to or equivalent to those described herein can be used in the practice or testing of the sediment-trapping bottle cap, suitable methods and materials are described above. All publications, patent applications, patents, and other references mentioned herein are incorporated by reference in their entirety to the extent allowed by applicable law and regulations. The sediment-trapping bottle cap may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A sediment-trapping bottle cap, comprising:
a cap body comprising a body opening and a chamber;
a socket in the cap body; and
a receptacle adapted to fit within the chamber, the receptacle comprising a receptacle opening and a ball member sized to be rotatably positioned in the socket such that the receptacle is rotatable within the chamber.

2. The sediment-trapping bottle cap of claim 1, wherein the socket comprises two sockets, one on either side of the cap body, and wherein the ball member comprises two ball members on either side of the receptacle such that each ball member is positioned in each socket.

3. The sediment-trapping bottle cap of claim 2, wherein the two ball members are positioned proximate the receptacle opening, and wherein a center of mass of the receptacle is below the receptacle opening such that the receptacle is suspended from the two ball members with the receptacle opening facing up.

4. The sediment-trapping bottle cap of claim 3, wherein the body opening comprises threads adapted to mate with a bottle.

5. The sediment-trapping bottle cap of claim 3, wherein the receptacle is substantially hemispherical.

6. The sediment-trapping bottle cap of claim 1, wherein the body opening comprises threads adapted to mate with a bottle.

7. The sediment-trapping bottle cap of claim 1, wherein the receptacle is substantially hemispherical.

8. The sediment-trapping bottle cap of claim 7, wherein the receptacle comprises a collection area to collect sediment.

9. The sediment-trapping bottle cap of claim 1, wherein the cap body is integrally formed from a single material.

10. The sediment-trapping bottle cap of claim 9, wherein the socket comprises two sockets, one on either side of the cap body, and wherein the ball member comprises two ball members on either side of the receptacle such that each ball member is positioned in each socket.

11. The sediment-trapping bottle cap of claim 10, wherein the two ball members are positioned proximate the receptacle opening, and wherein a center of mass of the receptacle is below the receptacle opening such that the receptacle is suspended from the two ball members with the receptacle opening facing up.

12. A method of using the sediment-trapping bottle cap of claim 1, comprising:
attaching the sediment-trapping bottle cap to a bottle containing a liquid;
inverting the bottle with the sediment-trapping bottle cap in place;
allowing sediment to settle into the receptacle; and
rotating the bottle to an upright position while substantially maintaining an orientation of the bottle, such that the receptacle is able to rotate inside the cap body due to gravity.

13. The method of claim 12, wherein the socket comprises two sockets, one on either side of the cap body, and wherein the ball member comprises two ball members on either side of the receptacle such that each ball member is positioned in each socket.

14. The method of claim 13, wherein the two ball members are positioned proximate the receptacle opening, and wherein a center of mass of the receptacle is below the receptacle opening such that the receptacle is suspended from the two ball members with the receptacle opening facing up.

15. The method of claim 12, wherein attaching the sediment-trapping bottle cap to a bottle comprises screwing the sediment-trapping bottle cap onto the top of the bottle.

16. The method of claim 12, wherein allowing sediment to settle into the receptacle comprises allowing time to pass sufficient for the sediment to settle while the bottle is inverted.

17. A sediment-trapping bottle cap, comprising:
a cap body comprising a first opening and a chamber;
pivot means in the cap body; and
a means for sediment collection adapted to fit within the chamber, the means for sediment collection comprising a second opening and a ball member sized to be rotatably positioned in the pivot means such that the means for sediment collection is rotatable within the chamber.

18. The sediment-trapping bottle cap of claim 17, wherein the pivot means comprises two sockets, one on either side of the cap body, and wherein the ball member comprises two ball members on either side of the means for sediment collection such that each ball member is positioned in each socket.

19. The sediment-trapping bottle cap of claim 18, wherein the two ball members are positioned proximate the second opening, and wherein a center of mass of the means for sediment collection is below the second opening such that the means for sediment collection is suspended from the two ball members with the second opening facing up.

20. The sediment-trapping bottle cap of claim 19, wherein the first opening comprises threads adapted to mate with a bottle.
